(19) United States
(12) Patent Application Publication
(10) Pub. No.: US 2025/0027566 A1
(43) Pub. Date: Jan. 23, 2025

(54) SEALING SYSTEM FOR MECHANICAL MEMBERS

(71) Applicant: DEVELOPMENT SERVICE S.R.L., Varese (Busto Arsizio) (IT)

(72) Inventor: Marco MARCANTE, Lonate pozzolo (Varese) (IT)

(21) Appl. No.: 18/711,816

(22) PCT Filed: Nov. 15, 2022
(86) PCT No.: PCT/IB2022/060976

§ 371 Date: May 20, 2024

(30) Foreign Application Priority Data
Nov. 23, 2021 (IT) 102021000029588

(51) Int. Cl. F16J 15/34

(52) U.S. Cl. CPC F16J 15/3436

(57) ABSTRACT

A sealing system having a lip seal that has an inner lip portion and an outer lip portion, and a toroidal tensioning element positioned between the inner lip portion and the outer lip portion for keeping the lip seal under tension is provided. An annular thruster element is partially inserted in the lip seal between one of the inner and outer lip portions and the toroidal tensioning element.

### CROSS-REFERENCE TO RELATED APPLICATIONS

This application is a National Phase Application of PCT International Application No. PCT/IB2022/060976, having an International Filing Date of Nov. 15, 2022 which claims the benefit of priority to Italian Patent Application No. 102021000029588, filed Nov. 23, 2021, each of which is hereby incorporated by reference in its entirety.

### FIELD OF THE INVENTION

The present invention relates generally to sealing systems used in mechanical members for containing liquid or gaseous leaks, both within components and to the atmosphere.

### BACKGROUND OF THE INVENTION

Many sealing systems used today in the industrial sector use a soft component, mainly thermoplastic, that is loaded with different compounds and installed in a respective seat. The pressure generated by the gas or process liquid promotes the expansion of the soft component and therefore facilitates the contact of the seal itself, thereby improving the performance thereof.

However, these types of sealing systems currently used in industry do not always minimize the leaks between pressurized components, especially when metal components are involved. The cause of the sub-optimal behavior of current sealing systems may be attributed to several factors, for example:
the pressure of the working fluid does not sufficiently deform the soft sealing element thereby preventing perfect contact with the surfaces;
the geometric tolerances of the metal components prevent perfect contact between the soft sealing element and the seat thereof;
the roughness of metal surfaces may cause leaks, especially in worn components.

### SUMMARY OF THE INVENTION

An object of the present invention is to provide a sealing system capable of overcoming the aforementioned limits with reference to current sealing systems and thus of minimizing, if not canceling, fluid leaks, especially where a particular sealing performance is required.

Another object of the invention is to propose a sealing system capable of operating effectively under any condition and with any type of fluid and which is also immune from dirt carried by the fluid.

Another object of the invention is to provide a sealing system that may be used in multiple devices for containing, intercepting and regulating the flow of a fluid, without requiring a significant redesign of such devices.

These purposes are achieved by a sealing system, a sealing assembly and a device as described and claimed herein.

Preferred or advantageous embodiments of the sealing system and of the devices according to the present invention are also described.

### BRIEF DESCRIPTION OF THE DRAWINGS

The features and advantages of the invention will become apparent from the description below of the preferred embodiments thereof, given by way of non-limiting example, with reference to the attached figures, wherein:

FIG. 1 is a cross-section of the sealing assembly according to the present invention;

FIG. 2 is an axial section of a ball valve wherein positions for the possible installation of a sealing assembly according to the present invention are indicated; and

FIG. 3 is an axial section of a ball valve portion at the sealing assembly between a ball seat and a flange of the valve body.

### DETAILED DESCRIPTION

In the drawings, the reference number 1 indicates a sealing system according to the present invention.

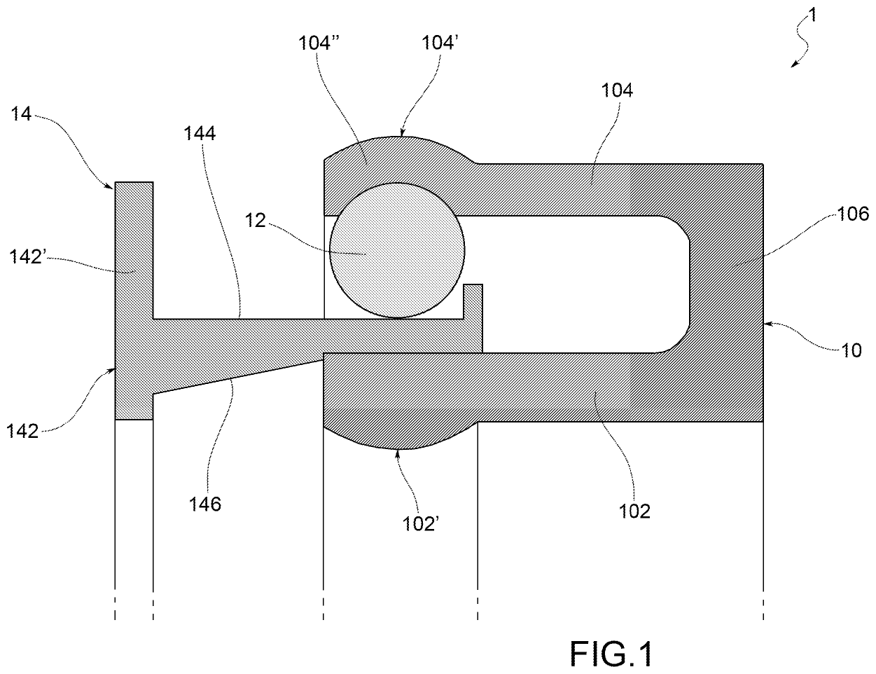

The sealing system 1, whereof FIG. 1 represents the cross section, has a toroidal shape, i.e., it consists of elements having an annular shape. In the following description, the terms “axial” and “radial” will be used with reference to parallel and perpendicular directions respectively, to the axis of the sealing system 1 passing through the center thereof and perpendicular to planes wherein the annular elements of the sealing system lie.

In a general embodiment, the sealing system 1 comprises a lip seal 10, a toroidal tensioning element 12 and an annular thruster element 14.

The lip seal 10 comprises an inner lip portion 102 and an outer lip portion 104. The two inner lip portion 102 and outer lip portion 104 are therefore the two portions of the gasket intended to achieve the sealing effect when the gasket is inserted between two surfaces.

For example, the two lip portions 102, 104 are substantially parallel to each other.

The two lip portions 102, 104 are connected to each other by an intermediate connection portion 106.

The two lip portions 102, 104 and the intermediate portion 106 confer an overall “C” shape to the lip seal 10.

In one embodiment, the inner lip portion 102 and outer lip portion 104 form, on the respective radially outer sides, convex distal surfaces 102′, 104′ suitable for making respective points of contact with respective surfaces among which the lip seal is inserted in order to prevent the passage of a fluid.

The toroidal tensioning element 12 is positioned between the inner lip portion 102 and the outer lip portion 104 in order to keep the lip seal 10 under tension.

In other words, the tensioning element 12 is mainly used to maintain a controlled pressure in the lip seal, for example to compensate for wearing of the lips, changes in the volume or stiffness of the elastomer whereof the seal is constituted, as well as the effect of temperature or atmospheric changes.

For example, the toroidal tensioning element 12 is positioned between the free ends of the lip portions 102, 104.

In one embodiment, the toroidal tensioning element 12 is made with a helical spring.

In one embodiment, the toroidal tensioning element 12 has, in section, a maximum diameter that is smaller than the distance between the two lip portions 102, 104.

In one embodiment, a distal end portion 104″ of one of the inner lip portion 102 and the outer lip portion 104 has a concave shape and the toroidal tensioning element 12 is partially accommodated by shape coupling in such distal end portion.

The annular thruster element 14 performs the function of further pre-loading the lip seal 10 such as to increase the specific pressure of the lip portions 102, 104 against the respective surfaces.

For this purpose, the annular thruster element 14 is partially inserted into the lip seal 10 between one of the inner lip portion 102 and outer lip portion 104 and the toroidal tensioning element 12.

The annular thruster element 14 forms, or is provided with, an outer end portion 142 axially protruding from the lip seal 10 in order to be engageable so as to cause an axial translation of the annular thruster element 14 towards the interior of the lip seal 10, i.e., towards the intermediate connection portion 106.

The annular thruster element 14 has a wedge shape such that an axial translation of the annular thruster element 14 causes radial divarication of the lip seal.

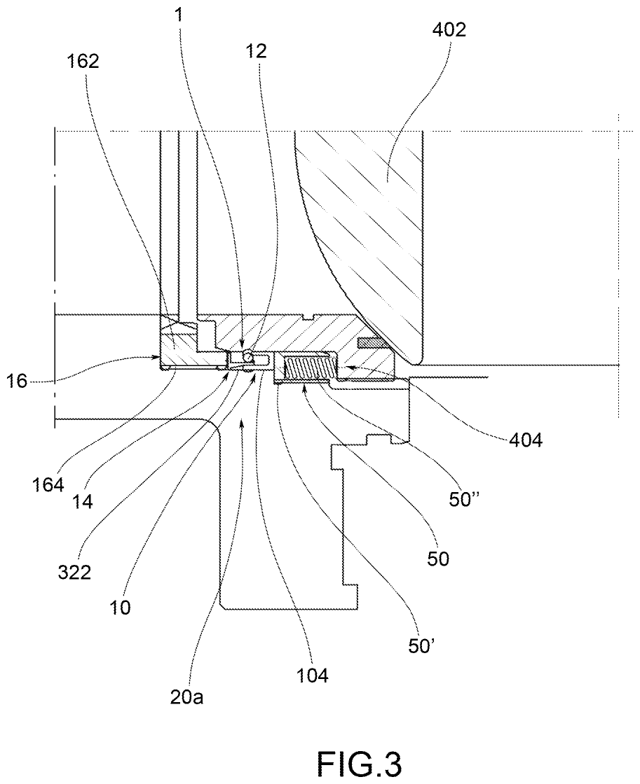

In FIGS. 1 and 3, the annular thruster element 14 is inserted between the toroidal tensioning element 12 and the inner lip portion 102. In this case, the axial translation of the annular thruster element 14 also results in radial enlargement of the toroidal tensioning element 12, and therefore in an increase in the load thereof that transfers to the lip seal 10.

In one embodiment, the annular thruster element 14 forms a substantially flat radially external wall 144, on which, for example, the toroidal tensioning element 12 rests, and an at least partially inclined radially internal wall 146, which internal wall 146 confers a wedge-shaped structure to the annular thruster element 14.

In one embodiment, the outer end portion 142 of the annular thruster element 14 forms a flat head 142′ substantially perpendicular to the axis of translation of the annular thruster element 14. The flat head 142′ acts as an abutment element for a register member 16 that is operable to cause a controlled translation of the annular thruster element 14.

Therefore, a sealing assembly 20 comprising the sealing system 1 described above and the register member 16 that acts upon the annular thruster element 14 is also an object of the present invention.

According to another general aspect thereof, the present invention relates to a device for containing a fluid or for intercepting or regulating a flow of a fluid, comprising a first surface and a second surface, and a sealing assembly 20 as described above, wherein the lip seal 10 is interposed between the first and second surfaces to prevent the passage of the fluid therebetween.

In one embodiment, the register member 16 is formed by a threaded register ring screwed into a threaded ring seat.

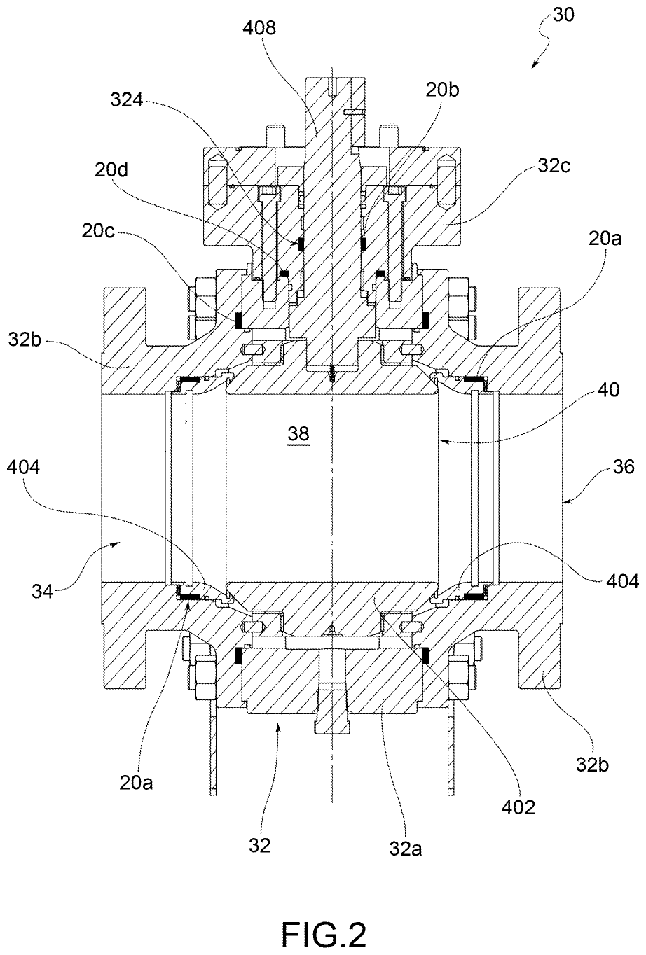

With reference to FIGS. 2 and 3, an example of the application of the sealing assembly 20 within a fluid flow interception device 30, such as a valve, will now be described.

The interception device 30 comprises a device body 32, which forms a fluid inlet conduit 34, a fluid outlet conduit 36 and, between the inlet conduit and the outlet conduit, a flow interception chamber 38.

A flow interception group 40 is sealingly housed in the flow interception chamber 38. The flow interception group 40 is operable to intercept the passage of fluid flow from the inlet conduit 34 to the outlet conduit 36.

At least one sealing assembly 20 is installed in the device body 32 with the lip seal 10 interposed between a surface of the interception group 40 and a surface of the device body 32.

In one embodiment, the register member 16 is formed by a threaded register ring 162 screwed into a threaded ring seat 164 obtained in the device body 32.

For example, the interception group 40 comprises a movable shutter member 402 and a pair of annular seats 404 that sealingly support the movable shutter member 402. For example, the movable shutter 402 is a spherical shutter rotatable with respect to the annular seats 404.

A pair of seat-body sealing assemblies 20a is installed in the device body 32, each having a lip seal 10 interposed between a respective annular seat 404 and a first surface 322 of the device body 32.

In one embodiment, the interception group 40 is rotatably operable by means of a maneuvering stem 408 protruding from the flow interception chamber 38 such as to be pivotally engaged by a control handle—not shown.

At least one stem-body sealing assembly 20b is interposed between a surface of the maneuvering stem 408 and a second surface 324 of the device body 32.

In one embodiment, the device body 32 comprises a central portion 32a, two end flanges 32b connected to the central portion 32a, and a cover 32c fastened to the central portion 32a for supporting and guiding a maneuvering member of the interception group, for example the maneuvering stem 408.

As schematically shown in FIG. 2, at least one sealing assembly 20c, 20d is respectively interposed between each end flange 32b and the central portion 32a and/or between the cover 32c and the central portion 32a.

With reference to FIG. 3, in an embodiment wherein the interception group 40 comprises a ball shutter 402, each annular seat 404 of the pair of annular seats is kept elastically in contact with the spherical shutter by means of a seat-press ring 50.

The seat-press ring 50 is positioned in the device body 32 so as to act as an axial abutment element for the seat-body sealing system 20a on the opposite side with respect to the register ring 162.

Thus, the sealing system 1 is axially retained in the device body between the register ring 162 and the seat-press ring 50.

For example, the seat-press ring 50 comprises a ring body 50′ and elastic means, for example a plurality of springs 50″, housed in the ring body such as to act in compression against the spherical shutter 402.

The register ring may be provided with engagement means, for example a hexagonal inner surface, suitable for being engaged by a tool for the controlled translation thereof in the ring seat.

It should be noted that in at least some embodiments, while the lip seal is made of a soft material, e.g., an elastomer, the toroidal thruster element 14 may be made of a metallic material.

Therefore, the combination of a soft sealing element realized using a lip seal and a thruster element made of a rigid material that confers a preload to the soft element which is adjustable by means of the register member, which allows the specific pressure of the lip seal to be increased against the sealing seat, greatly increasing the seal of the assembly.

The proposed solution allows to minimize leaks without requiring low roughness surfaces in some cases difficult to obtain. Furthermore, the proposed sealing system allows to compensate for the geometric tolerances of the circularity and concentricity of the metal seal surfaces, since the lip seal is capable of adapting to seal surfaces.

The proposed sealing assembly is advantageously usable in cryogenic applications. The devices used in these applications are subject to high losses due to the different thermal expansion of the lip seal compared to that of the metal parts. Losses occur in particular due to the loss of contact of the outer lip portion with the respective surface of the device body due to the greater thermal expansion of the thermoplastic element.

With the proposed sealing assembly, the preload supplied by the wedge-shaped register member during mounting step of the device ensures an optimal seal over time, minimizing the effect of the thermal contraction of the lip seal in the seat thereof, since the seal is constrained in position by the register member.

It should be noted that the sealing assembly according to the present invention, described above and represented in the drawings, by way of a non-limiting example, applied to a ball valve, may be installed in all types of devices for the interception of a fluid and in general in all applications that require minimal leakage.

Furthermore, since the proposed sealing assembly does not require the redesigning of the components of the device in which it is installed, the assembly may also be mounted in devices that are already in use, replacing traditional sealing systems.

To the embodiments of the system, assembly and device according to the present invention, a person skilled in the art may, in order to meet contingent needs, make changes, adaptations, and replacements of elements with functionally equivalent ones without departing from the scope of protection as described and claimed herein. Each of the features described as belonging to a possible embodiment may be obtained independently of the other described embodiments.

What is claimed is:

1. A sealing system, comprising:
a lip seal comprising an inner lip portion and an outer lip portion;
a toroidal tensioning element positioned between the inner lip portion and the outer lip portion for keeping the lip seal under tension; and
an annular thruster element partially inserted into the lip seal between one of said inner lip and outer lip portions and the toroidal tensioning element, the annular thruster element forming an outer end portion axially protruding from the lip seal to be engageable so as to cause an axial translation of the annular thruster element towards an inside of the lip seal, the annular thruster element having a wedge shape so that said axial translation of the annular thruster element causes a radial divarication of the lip seal.

2. The sealing system of claim 1, wherein the toroidal tensioning element is made with a helical spring.

3. The sealing system of claim 1, wherein a distal end portion of one between the inner lip and outer lip portions has a concave shape, and wherein the toroidal tensioning element is partially accommodated by shape coupling in said distal end portion.

4. The sealing system of claim 1, wherein the annular thruster element forms a radially external wall that is substantially flat, on which the toroidal tensioning element rests, and a radially internal wall that is at least partially inclined.

5. The sealing system of claim 1, wherein the inner and outer lip portions form, on respective radially outer sides, convex distal surfaces suitable to make respective points of contact with respective seal surfaces.

6. A sealing assembly comprising a sealing system claims comprising
a lip seal comprising an inner lip portion and an outer lip portion;
a toroidal tensioning element positioned between the inner lip portion and the outer lip portion for keeping the lip seal under tension; and
an annular thruster element partially inserted into the lip seal between one of said inner and outer lip portions and the toroidal tensioning element, the annular thruster element forming an outer end portion axially protruding from the lip seal to be engageable so as to cause an axial translation of the annular thruster element towards an inside of the lip seal, the annular thruster element having a wedge shape so that said axial translation of the annular thruster element causes a radial divarication of the lip seal; and
a register member suitable to engage the outer end portion of the annular thruster element, the register member being operable to cause a controlled translation of the annular thruster element.

7. A device for containing a fluid or for intercepting a fluid flow, comprising a first surface and a second surface and the sealing assembly of claim 6 having the lip seal interposed between said first and second surfaces to prevent a passage of the fluid therebetween.

8. The device of claim 7, wherein the register member is formed by a threaded register ring screwed into a threaded ring seat.

9. An interception device for intercepting a fluid flow, comprising:
a device body forming a fluid inlet conduit, a fluid outlet conduit and, between the fluid inlet conduit and the fluid outlet conduit, a flow interception chamber;
a flow interception group sealingly housed in the flow interception chamber and operable for intercepting a passage of the fluid flow from the fluid inlet conduit to the fluid outlet conduit; and
at least one sealing assembly according to claim 6 having the lip seal interposed between a surface of the flow interception group and a surface of the device body.

10. The interception device of claim 9, wherein the register member is formed by a threaded register ring screwed into a threaded ring seat provided in the device body.

11. The interception device according of claim 9, wherein the flow interception group comprises:
a movable shutter member;
a pair of annular seats sealingly supporting the movable shutter member; and
a pair of seat-body sealing assemblies, each having a lip seal interposed between a respective annular seat and the surface of the device body.

12. The interception device of claim 9, wherein the flow interception group is rotatably operable by a maneuvering stem protruding from the flow interception chamber so as to be rotatably engaged by a control handle, at least one body-stem seal assembly being interposed between a surface of the maneuvering stem and the surface of the device body.

13. The interception device of claim 9, wherein the device body comprises a central portion, two end flanges connected to the central portion, and a cover fastened to the central portion for supporting and guiding a maneuvering member of the flow interception group, and wherein at least one sealing assembly is interposed between each end flange and the central body portion and/or between each end flange and the cover and/or between the cover and the central portion.

14. The interception device of claim 11, wherein the flow interception group comprises a ball shutter, and wherein each annular seat of the pair of annular seats is kept elastically in contact with the ball shutter by a seat-press ring, the seat-press ring being positioned in the device body so as to act as an axial abutment element for the seat-body sealing assemblies on an opposite side with respect to a threaded register ring.
